(19) United States
(12) Patent Application Publication
(10) Pub. No.: US 2009/0244282 A1
(43) Pub. Date: Oct. 1, 2009

(54) VEHICLE CAMERA SYSTEM

(76) Inventor: FRANCISCO JOSE EGUIGUREN, Hillsborough, NJ (US)

Correspondence Address: ROBERTS & ROBERTS, LLP;ATTORNEYS AT LAW, P.O. BOX 484, PRINCETON, NJ, 08542-0484, US

(21) Appl. No.: 12/060,333

(22) Filed: Apr. 1, 2008

(51) Int. Cl. H04N 7/18

(52) U.S. Cl. 348/148; 348/E07.085

(57) ABSTRACT

A vehicle camera system including a receiver device which is capable of wirelessly communicating with an electronic camera arrangement. The receiver device is capable of switching a screen from its normal visual display mode to a real-time camera image display mode. The receiver device may be attached to an existing screen, such as a screen of a global positioning satellite (GPS) apparatus.

### BACKGROUND OF THE INVENTION

1. Field of the Invention

The present invention relates to camera systems, such as wireless camera display systems for vehicles and the like. More particularly, the invention relates to camera systems having a receiver device which is attachable to an existing screen, such as a screen of a GPS unit, and which receiver device is capable of switching the screen from its normal visual display mode to a real-time camera image display mode.

2. Description of the Related Art

Vehicle camera systems, often referred to as “back-up camera systems” or “reverse camera systems”, are well known in the art, and are used to provide a driver with a rearward view from his vehicle. These systems are typically sold as user-installable kits including a camera component which is mounted to the rear of a vehicle, and a receiver component such as a monitor screen which is mounted to the vehicle's dashboard. When the camera component is activated, it sends a signal to the dashboard monitor screen, and a user is able to observe the view behind their vehicle.

Conventional vehicle camera systems are often highly expensive, since the system kit must include a monitor screen for viewing the camera's signal. In addition, the mounting of such a monitor screen on the vehicle's dashboard takes up valuable space. It would therefore be desirable to devise an inexpensive camera system which does not require the addition of its own dashboard monitor screen. The present invention provides a solution to these problems.

The present invention provides a camera system including a receiver device which is attachable to an existing monitor or screen, such as a GPS unit, of the vehicle. This eliminates the need for providing an additional dashboard monitor for the camera system itself. When a camera component of the camera system is activated, a wireless signal is sent to the inventive receiver device. The receiver device receives the wireless camera signal, and switches the existing screen from its normal visual display mode to a real-time camera image display mode, such that the rear view from the camera is displayed on the existing screen. When the camera is turned off, the inventive receiver device switches the existing screen from this real-time camera image display mode back its normal visual display mode, such as a GPS mode. Since an additional dashboard monitor for the vehicle camera system is not necessary, this invention saves valuable dashboard space and allows for the production of an economical, affordable vehicle camera system.

### SUMMARY OF THE INVENTION

The invention provides a receiver device for switching a screen from a visual display mode to a real-time camera image display mode which comprises:

a) a housing comprising an antenna;
b) a wireless receiver within the housing which wireless receiver is electrically connected to the antenna, and which wireless receiver is capable of wirelessly receiving real-time video data via the antenna from an electronic camera arrangement;
c) a microprocessor within the housing, which microprocessor is electrically connected to the wireless receiver and the antenna, and, when said microprocessor is electrically connected to a screen, said microprocessor is capable of alternately switching the screen from a visual display mode to a real-time camera image display mode when real-time video data is received by the wireless receiver from the electronic camera arrangement, and which microprocessor is capable of switching the screen to a visual display mode when such real-time video data is not received by the wireless receiver; and
d) a connector for electrically connecting the microprocessor to the screen.

The invention also provides a wireless camera display system, which comprises:

I) a receiver device for switching a screen from a visual display mode to a real-time camera image display mode which comprises:
a) a housing comprising an antenna;
b) a wireless receiver within the housing which wireless receiver is electrically connected to the antenna, and which wireless receiver is capable of wirelessly receiving real-time video data via the antenna from an electronic camera arrangement;
c) a microprocessor within the housing, which microprocessor is electrically connected to the wireless receiver and the antenna, and, when said microprocessor is electrically connected to a screen, said microprocessor is capable of alternately switching the screen from a visual display mode to a real-time camera image display mode when real-time video data is received by the wireless receiver from the electronic camera arrangement, and which microprocessor is capable of switching the screen to a visual display mode when such real-time video data is not received by the wireless receiver; and
d) a connector for electrically connecting the microprocessor to the screen; and
   II) an electronic camera arrangement comprising at least one camera which is capable of wirelessly transmitting video data to the wireless receiver of said receiver device.

The invention further provides a method of switching a screen from a visual display mode to a real-time camera image display mode comprising the steps of:

A) providing a wireless camera display system, which comprises:
I) a receiver device which is wirelessly connectable to an electronic camera arrangement, said receiver device comprising:
   a) a housing comprising an antenna;
   b) a wireless receiver within the housing which wireless receiver is electrically connected to the antenna, and which wireless receiver is capable of wirelessly receiving real-time video data via the antenna from an electronic camera arrangement;
   c) a microprocessor within the housing, which microprocessor is electrically connected to the wireless receiver and the antenna, and, when said microprocessor is electrically connected to a screen, said microprocessor is capable of alternately switching the screen from a visual display mode to a real-time camera image display mode when real-time video data is received by the wireless receiver from the electronic camera arrangement, and which microprocessor is capable of switching the screen to a visual display mode when such real-time video data is not received by the wireless receiver; and
   d) a connector for electrically connecting the microprocessor to the screen; and
II) an electronic camera arrangement comprising at least one camera which is capable of wirelessly transmitting video data to the wireless receiver of said receiver device;
   B) connecting the receiver device, via its connector, to a screen such that the microprocessor is electrically connected to the screen;
   C) activating the electronic camera arrangement such that video data is gathered by at least one camera of said electronic camera arrangement;
   D) wirelessly transmitting said video data from the at least one camera of said electronic camera arrangement;
   E) wirelessly receiving said video data via the wireless receiver of the receiver device; and
   F) visually displaying the received video data on the screen, via the microprocessor of the receiver device.

### BRIEF DESCRIPTION OF THE DRAWINGS

FIG. 1 shows a schematic representation of a receiver device of this invention.

FIG. 2 shows a schematic representation of a receiver device of the invention, which is attached to a screen.

FIG. 3 shows a schematic representation of a receiver device of the invention, which is attached to a screen on a vehicle's dashboard.

FIG. 4 shows a schematic representation of a wireless camera display system attached to a vehicle, including an electronic camera arrangement electrically connected to the vehicle's reverse lights.

### DETAILED DESCRIPTION OF THE INVENTION

The invention relates to camera display systems. The invention provides a receiver device for switching a screen from a visual display mode to a real-time camera image display mode. The invention further provides a wireless camera display system including a receiver device, and an electronic camera arrangement which is capable of transmitting data to the receiver device.

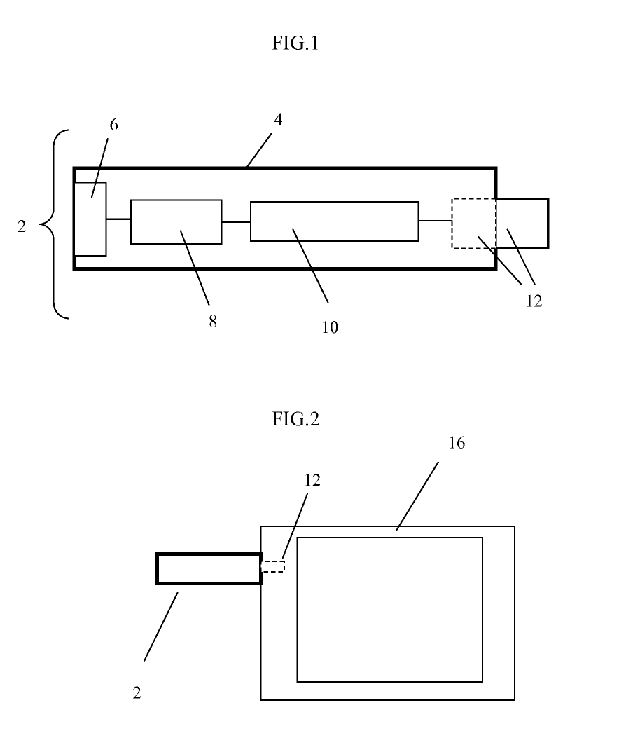

FIG. 1 shows a receiver device 2 of the invention, which is capable of switching a screen from a visual display mode to a real-time camera image display mode. The receiver device 2 comprises a housing 4, which is preferably suitably shaped to define an internal cavity suitable for housing any necessary internal electrical components of the receiver device. The housing 4 may comprise any suitable conventional material such as plastic, rubber, metal, or the like. The housing 4 comprises an antenna 6 which is capable of receiving wireless data signals, such as those sent from an electronic camera arrangement as described below.

The receiver device 2 further includes a wireless receiver 8 within the housing 4, which wireless receiver 8 is electrically connected, such as via wires or the like, to the antenna 6. The wireless receiver 8 is capable of wirelessly receiving real-time video data via the antenna 6 from an electronic camera arrangement, as described below. Suitable wireless receivers are well known in the art.

The receiver device 2 further includes a microprocessor 10 within the housing 4. Such microprocessors are well known in the art. The microprocessor 10 of this invention is electrically connected, such as via wires or the like, to the wireless receiver 8 and the antenna 6. The microprocessor 10 is further capable of being electrically connected to a screen, as described below. As also described in detail below, a key feature of this invention is that the microprocessor 10 is capable of alternately switching the screen between a visual display mode to a real-time camera image display mode.

The receiver device 2 further comprises a connector 12 for electrically connecting the microprocessor 10 to a screen as described below. The connector 12 may comprise any suitable conventional means of electrically connecting two components internally or externally, such as wires, projections or ports, pin connectors such as serial pin connectors, IEEE 1394 interface connectors such as Firewire connectors, high performance serial bus connectors, and any universal serial bus (USB)-type connector such as a USB, mini-USB, thin USB, and the like. Preferred connectors nonexclusively include USB, mini USB, and thin USB connectors. In certain embodiments, the inventive receiver device 2 may be internally connected or wholly integrated within an existing electronic apparatus. In other embodiments, the inventive receiver device is externally connected to such an existing electronic apparatus. In the embodiment shown in FIG. 1, for example, the connector comprises a USB-type projection which extends outwardly from inside the housing, such that it may be directly connected to a USB-type port of an existing electronic apparatus.

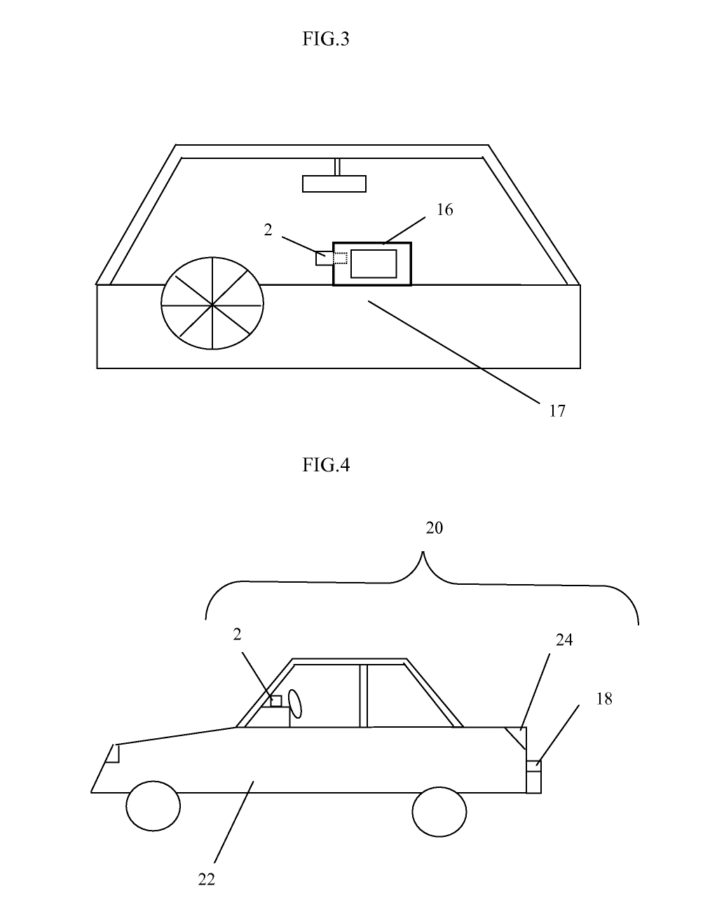

As stated above, the receiver device 2 is preferably capable of being connected to a screen, which may comprise a monitor or the like, and which screen is suitable for viewing visual images. FIG. 2 shows such a screen 16 with a receiver device 2 connected thereto. FIG. 3 shows a receiver device 2 connected to a screen 16 on a vehicle dashboard 17. In certain embodiments, the screen is a liquid crystal display (LCD) screen, or the like. In a preferred embodiment of this invention, the screen 16 is a component of an existing electronic apparatus or system. That is, the screen 16 is preferably normally used as a component of an apparatus or system which is separate from the inventive wireless camera display system. For example, in a preferred embodiment, the screen 16 is an integral part of a global positioning satellite (GPS) receiver apparatus.

Regarding the camera component, an electronic camera arrangement 18 is present, which arrangement 18 comprises at least one camera which is capable of transmitting wireless video data to the wireless receiver 8 of the receiver device 2. That is, the electronic camera arrangement 18 preferably comprises a wireless transmitter, such as those which are well known in the art, for transmitting such wireless video data to the wireless receiver 8. Such wireless video data may be present in any suitable conventional format such as avi, wmv, mpg, raw data, and the like. Suitable cameras useful for the electronic camera arrangement nonexclusively include video cameras capable of transmitting wireless signals, such as stand-alone wireless backup cameras. In addition, the electronic camera arrangement 18 is preferably capable of providing still photographs if desired. In certain embodiments, the electronic camera arrangement 18 may be present together with the receiver device 2 in the form of a wireless camera display system 20, as shown in FIG. 4. However, in other embodiments, it is possible that the receiver device 2 and the electronic camera arrangement 18 may be present independently as components of separate systems.

In practice, the electronic camera arrangement 18 is activated such that video data is gathered by at least one camera of said arrangement 18. Such activation may be accomplished in a variety of ways, as described below. The video data is then wirelessly transmitted from the at least one camera of said electronic camera arrangement 18 and is wirelessly received via the wireless receiver 8 of the receiver device 2. The received video data is then visually displayed on a screen 16, as described herein.

A key feature of this invention is that when the microprocessor 10 is electrically connected to a screen 16, the microprocessor 10 is programmed such that it is capable of alternately switching the screen 16 from a “visual display mode” to a “real-time camera image display mode”, when real-time video data is received by the wireless receiver 8, from the electronic camera arrangement 18, as described herein. That is, in a “visual display mode” or normal use mode, the screen 16 functions according to its normally intended use, such as by displaying GPS information or the like. When real-time video data is received by the wireless receiver 8, from the electronic camera arrangement 18, the microprocessor 10 switches the screen 16 from its normal visual display mode to a “real-time camera image display mode”, causing the received real-time video data to be visually displayed on the screen 16. The microprocessor 10 is also capable of switching the screen 16 back to its visual display mode, such as when such real-time video data is not being received by the wireless receiver 8. The switching function of the microprocessor may be conducted using any suitable conventional means, such as software or the like which interacts with the screen 16 and/or its associated system in order to switch between the electronic camera arrangement's functions, the screen's functions, or the existing apparatus's other functions.

The receiver device 2 may optionally further comprise a data memory which is electrically connected to the microprocessor 10. Such a data memory is capable of recording and storing video data received by the wireless receiver 8. This would allow such video data to be recalled from the data memory via the microprocessor 10 and be visually displayed on the screen 16.

A power source preferably provides power to the receiver device 2 and/or the electronic camera arrangement 18. These components may or may not share a single power source. Suitable power sources include any conventional power supplying means known in the art such as batteries, solar cells, DC or AC power, and the like. In one embodiment, the power source comprises a battery or batteries. In another embodiment, the power source comprises a vehicle's DC power source. In still another embodiment, power for the receiver device 2 is drawn via its connection to the screen 16 of an existing apparatus.

The inventive wireless camera display system 20 has several uses, in a variety of surveillance situations. In certain preferred embodiments, the wireless camera display system 20 is attached to a vehicle 22, such as an automobile, as shown in FIGS. 3 and 4. For this kind of use, the electronic camera arrangement 18 is preferably attached at or near the rear of the vehicle 22, or in a position such that it may provide a driver with a rearward view from the vehicle. In a preferred embodiment, the electronic camera arrangement 18 is electrically connected to vehicle's backup or reverse lights 24, such that the electronic camera arrangement 18 is activated when the vehicle's reverse lights 24 are turned on. A vehicle's reverse lights are typically white lights which are located at a rear of the vehicle, and which are turned on when the vehicle is shifted into reverse gear. Activation of the electronic camera arrangement 18 begins the process wherein real-time video data is gathered by at least one camera of said electronic camera arrangement 18, and such data is wirelessly transmitted to the receiver device 2, as described above. The electronic camera arrangement 18 may be activated in a variety of ways, including manual activation via a switch or the like, or automatic activation such as when a reverse gear of the vehicle is engaged.

The invention further provides a method of switching a screen from a visual display mode to a real-time camera image display mode, as described above. This method includes the steps of: providing a wireless camera display system as described above; connecting the receiver device, via its connector, to a screen such that the microprocessor is electrically connected to the screen; activating the electronic camera arrangement such that video data is gathered by at least one camera of said electronic camera arrangement; wirelessly transmitting said video data from the at least one camera of said electronic camera arrangement; wirelessly receiving said video data via the wireless receiver of the receiver device; and visually displaying the received video data on the screen, via the microprocessor of the receiver device, as described above.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A receiver device for switching a screen from a visual display mode to a real-time camera image display mode which comprises:
a) a housing comprising an antenna;
b) a wireless receiver within the housing which wireless receiver is electrically connected to the antenna, and which wireless receiver is capable of wirelessly receiving real-time video data via the antenna from an electronic camera arrangement;
c) a microprocessor within the housing, which microprocessor is electrically connected to the wireless receiver and the antenna, and, when said microprocessor is electrically connected to a screen, said microprocessor is capable of alternately switching the screen from a visual display mode to a real-time camera image display mode when real-time video data is received by the wireless receiver from the electronic camera arrangement, and which microprocessor is capable of switching the screen to a visual display mode when such real-time video data is not received by the wireless receiver; and
d) a connector for electrically connecting the microprocessor to the screen.

2. The receiver device of claim 1 wherein the screen is an LCD screen.

3. The receiver device of claim 1 wherein the screen is an integral part of a global positioning satellite receiver apparatus.

4. The receiver device of claim 1 wherein the electronic camera arrangement comprises at least one camera which is capable of transmitting wireless video data to the wireless receiver.

5. The receiver device of claim 1 wherein the connector comprises a USB-type connector.

6. The receiver device of claim 1 wherein the microprocessor is capable of switching the screen from a real-time camera image display mode back to its visual display mode, when real-time video data is not being received by the wireless receiver.

7. The receiver device of claim 1 which further comprises a data memory electrically connected to the microprocessor, which data memory is capable of recording and storing video data received by the wireless receiver, and wherein such video data may be recalled from the data memory via the microprocessor and be visually displayed on the screen.

8. A wireless camera display system, which comprises:
I) a receiver device for switching a screen from a visual display mode to a real-time camera image display mode which comprises:
a) a housing comprising an antenna;
b) a wireless receiver within the housing which wireless receiver is electrically connected to the antenna, and which wireless receiver is capable of wirelessly receiving real-time video data via the antenna from an electronic camera arrangement;
c) a microprocessor within the housing, which microprocessor is electrically connected to the wireless receiver and the antenna, and, when said microprocessor is electrically connected to a screen, said microprocessor is capable of alternately switching the screen from a visual display mode to a real-time camera image display mode when real-time video data is received by the wireless receiver from the electronic camera arrangement, and which microprocessor is capable of switching the screen to a visual display mode when such real-time video data is not received by the wireless receiver; and
d) a connector for electrically connecting the microprocessor to the screen; and
II) an electronic camera arrangement comprising at least one camera which is capable of wirelessly transmitting video data to the wireless receiver of said receiver device.

9. The wireless camera display system of claim 8 wherein the screen is an LCD screen.

10. The wireless camera display system of claim 8 wherein the screen is an integral part of a global positioning satellite receiver apparatus.

11. The wireless camera display system of claim 8 wherein the connector comprises a USB-type connector.

12. The wireless camera display system of claim 8 wherein the receiver device further comprises a data memory electrically connected to the microprocessor, which data memory is capable of recording and storing video data received by the wireless receiver, and wherein such video data may be recalled from the data memory via the microprocessor and be visually displayed on the screen.

13. A method of switching a screen from a visual display mode to a real-time camera image display mode comprising the steps of:
A) providing a wireless camera display system, which comprises:
I) a receiver device which is wirelessly connectable to an electronic camera arrangement, said receiver device comprising:
a) a housing comprising an antenna;
b) a wireless receiver within the housing which wireless receiver is electrically connected to the antenna, and which wireless receiver is capable of wirelessly receiving real-time video data via the antenna from an electronic camera arrangement;
c) a microprocessor within the housing, which microprocessor is electrically connected to the wireless receiver and the antenna, and, when said microprocessor is electrically connected to a screen, said microprocessor is capable of alternately switching the screen from a visual display mode to a real-time camera image display mode when real-time video data is received by the wireless receiver from the electronic camera arrangement, and which microprocessor is capable of switching the screen to a visual display mode when such real-time video data is not received by the wireless receiver; and
d) a connector for electrically connecting the microprocessor to the screen; and
II) an electronic camera arrangement comprising at least one camera which is capable of wirelessly transmitting video data to the wireless receiver of said receiver device;
B) connecting the receiver device, via its connector, to a screen such that the microprocessor is electrically connected to the screen;
C) activating the electronic camera arrangement such that video data is gathered by at least one camera of said electronic camera arrangement;
D) wirelessly transmitting said video data from the at least one camera of said electronic camera arrangement;
E) wirelessly receiving said video data via the wireless receiver of the receiver device; and
F) visually displaying the received video data on the screen, via the microprocessor of the receiver device.

14. The method of claim 13 wherein the wireless camera display system is attached to a vehicle.

15. The method of claim 14 wherein the electronic camera arrangement of the wireless camera display system is electrically connected to vehicle reverse lights, such that the electronic camera arrangement is activated, as in step (C), when the vehicle reverse lights are turned on.

16. The method of claim 14 wherein the vehicle comprises an automobile.

17. The method of claim 13 which further comprises the step of switching a screen, via the microprocessor, from a visual display mode to a real-time camera image display mode when real-time video data is received by the wireless receiver from the electronic camera arrangement.

18. The method of claim 17 which further comprises the step of switching the screen, via the microprocessor, back to a visual display mode when real-time video data is not being received by the wireless receiver.

19. The method of claim 13 wherein the receiver device further comprises a data memory electrically connected to the microprocessor, which data memory is capable of recording and storing video data received by the wireless receiver, and wherein such video data may be recalled from the data memory via the microprocessor and be visually displayed on the screen.

20. The method of claim 19 which further comprises the step of recording and storing video data received by the wireless receiver, via the data memory.

21. The method of claim 13 wherein the screen is an LCD screen.

22. The method of claim 13 wherein the screen is an integral part of a global positioning satellite receiver apparatus.
